(19) United States
(12) Patent Application Publication
(10) Pub. No.: US 2016/0169238 A1
(43) Pub. Date: Jun. 16, 2016

(54) FAN AND ASSOCIATED AIRCRAFT

(71) Applicant: TECHNOFAN, BLAGNAC (FR)

(72) Inventor: Nicolas STEFANOVIC, BOULOC (FR)

(21) Appl. No.: 14/963,626

(22) Filed: Dec. 9, 2015

(30) Foreign Application Priority Data
Dec. 11, 2014 (FR) 14 62275

(51) Int. Cl. F04D 27/00; B64D 13/06; F04D 19/00; F04D 25/12; G01M 13/04; F04D 29/059; F04D 29/32; F04D 29/52; F04D 29/66; B64D 13/02; F04D 29/053

(52) U.S. Cl. CPC F04D 27/001; B64D 13/02; B64D 13/06; F04D 19/002; F04D 25/12; F04D 29/053; F04D 29/059; F04D 29/325; F04D 29/522; F04D 29/668; G01M 13/045

(57) ABSTRACT

The fan (20) includes:
a drive motor (26),
a shaft (28) coupled to the drive motor (26),
a wheel (30) supported by the shaft (28),
a support structure (24), including:
   an outer body (38),
   a duct (40) including a sidewall (48), the duct (40) defining, with the outer body (38), an inner space (50), and
   a housing (46) situated in the inner space (50) and in contact with the sidewall (48), the housing (46) defining an inner volume,
a ball bearing (32, 34) inserted between the shaft (28) and the support structure (24), and
a sensor (36) for measuring a mechanical parameter representative of the dynamic behavior of the bearing (32, 34), the sensor (36) being positioned in the inner volume defined by the housing (46).

### FIELD OF THE INVENTION

This patent application claims the benefit of document FR 14 62 275 filed on Dec. 11, 2014 which is hereby incorporated by reference.

The present invention relates to a fan. The invention also relates to an associated aircraft.

### BACKGROUND OF THE INVENTION

Aircraft ventilation circuits of airplanes incorporate fans to ensure the circulation of air in the ventilation ducts. Such fans rotate at a high speed comprised between 10,000 revolutions per minute and 30,000 revolutions per minute. Furthermore, it is desirable for the fans to have high reliability.

To that end, it is known to propose a fan including a shaft supporting A wheel and being carried by two ball bearings. The bearings are greased to prevent them from heating up and being quickly destroyed.

Depending on the case, such a fan ensures air circulation for pressurization and passenger comfort (air control system), cooling of components (electronic rack, maintaining temperature for food or other reasons) or refreshing the air (toilet ventilation). When a fan breaks, it is therefore very detrimental to the airplane in which the fan is installed. Thus, such a fan is subject to a very rigorous maintenance schedule, involving regular inspections and frequent changes of wearing parts, and in particular ball bearings, before the ball bearings become damaged.

Such a maintenance schedule and premature replacement of wearing parts is expensive for the operation of the airplane.

Document WO 03/020582 A also describes a device for monitoring the deterioration of the fan including a sensor attached on the outer structure of the fan. This device allows the detection of a malfunction of the fan, and in particular repeated impacts of the blades of the fan with the outer duct of the fan, these impacts risking leading to smoke production.

However, the aforementioned device only makes it possible to detect failures of the fan and does not make it possible to avoid failures before such failures occur. The implementation of the device is therefore difficult. In particular, expensive preventive maintenance must be established.

### SUMMARY OF THE INVENTION

There is therefore a need for a fan that is easier to implement. To that end, a fan is proposed including a drive motor, a shaft coupled to the drive motor, a wheel supported by the shaft and a support structure. The support structure includes an outer body, a duct comprising a sidewall, the duct defining, with the outer body, an inner space, and a housing situated in the inner space and in contact with the sidewall, the housing defining an inner volume. The fan includes at least one ball bearing inserted between the shaft and the support structure and a sensor for measuring a mechanical parameter representative of the dynamic behavior of the or each bearing, said sensor being positioned in the inner volume defined by the housing.

According to specific embodiments, the fan comprises one or more of the following features, considered alone or according to any technically possible combinations:
the housing includes an electronic board, the electronic board including the sensor.
the housing includes a processing chain connected to the sensor and able to perform a Fourier series decomposition of the vibrational behavior of the bearing.
the processing chain is able to perform a Fourier series decomposition of the vibrational behavior of the bearing for frequencies comprised between 10 Hz and 6 Hz.
the processing chain is able to perform a Fourier series decomposition of the vibrational behavior of the bearing for frequencies comprised between 10 Hz and 20 Hz.
the processing chain is able to calculate at least one mechanical energy associated with the vibrational behavior of the bearing over a frequency band and to compare the calculated mechanical energy to a reference level.
the reference level is the mechanical energy associated with the vibrational behavior of the bearing of a fan during normal operation on the considered frequency band.
the housing includes an electronic board, the electronic board including the sensor and the processing chain.
the sensor is a micro-electromechanical system.
the fan includes a single sensor for measuring a mechanical parameter representative of the dynamic behavior of the or each bearing.

The invention also relates to an aircraft including a fan as previously described.

### BRIEF DESCRIPTION OF THE DRAWINGS

Other features and advantages of the invention will appear upon reading the following description of embodiments of the invention, provided as an example only and in reference to the drawings, which are:

FIG. 1, a diagrammatic illustration of an aircraft including a fan,

FIG. 2, a longitudinal sectional view of the fan of FIG. 1, the fan including an electronic board, and

FIG. 3, a diagrammatic illustration of the components of the electronic board.

### DETAILED DESCRIPTION OF THE PREFERRED EMBODIMENTS

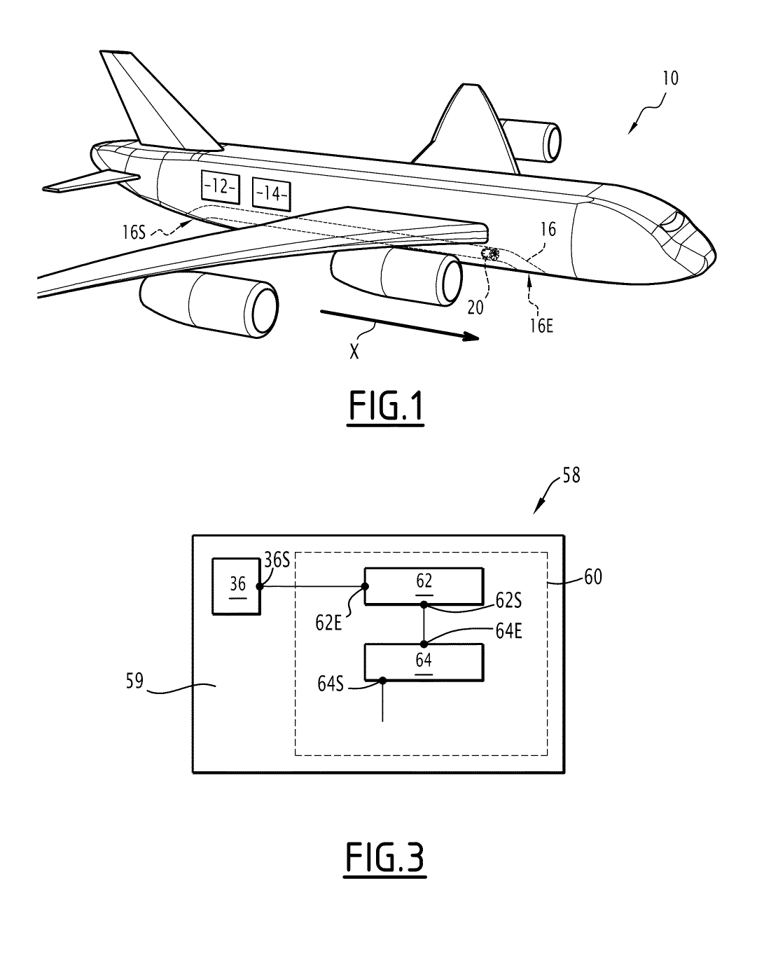

FIG. 1 shows an aircraft 10.

The aircraft 10 is for example an airplane, helicopter or drone.

According to the example of FIG. 1, the aircraft 10 is an airliner.

In the particular case that is illustrated, the aircraft 10 includes an electric grid 12, onboard equipment 14, an air duct 16 emerging outside the aircraft 10 and a fan 20 positioned at least partially in the air duct 16 and able to create a flow of air in the duct 16.

According to another example, air is withdrawn in the cargo area and expelled in the cargo area. This is in particular the case for fans 20 cooling electronic components.

The electric grid 12 is a high-voltage electric grid able to provide three-phase AC current with a voltage substantially equal to 115 V (Volts) or 200 V and an intensity substantially equal to 10 A (Amperes).

Other voltage and/or intensity values can be considered depending on the fan 20 in question.

The electric grid 12 comprises at least three connecting terminals making it possible to connect the fan 20 to each phase.

According to another alternative embodiment, the supply grid 12 is an electric grid of the DC (Direct Current) type able to provide a DC current.

Advantageously, the supply grid 12 is an electric grid of the HVDC (High Voltage Direct Current) type able to provide a high-voltage DC current.

According to this alternative embodiment, the electric grid 12 comprises at least two connecting terminals making it possible to connect the fan 20.

The onboard equipment 14 is equipment of the aircraft 10 to be cooled or that needs air to operate (pressurization, etc.) during at least certain operating phases of the aircraft 10. One example of such equipment is an onboard computer.

In FIG. 1, the air duct 16 extends substantially along a longitudinal movement axis X of the aircraft 10.

The air duct 16 includes an air inlet 16E positioned in the front part of the aircraft 10, an air outlet 16S positioned in the rear part of the aircraft 10, and a cylindrical segment in which a heat exchanger is positioned transversely.

The air inlet 16E and the air outlet 16S are suitable for allowing the circulation of the flow of air in the inner part of the duct 16.

The heat exchanger is thermally connected to the onboard equipment 14 and makes it possible to cool the equipment 14 when the heat exchanger is exposed to a flow of air circulating in the inner duct 16.

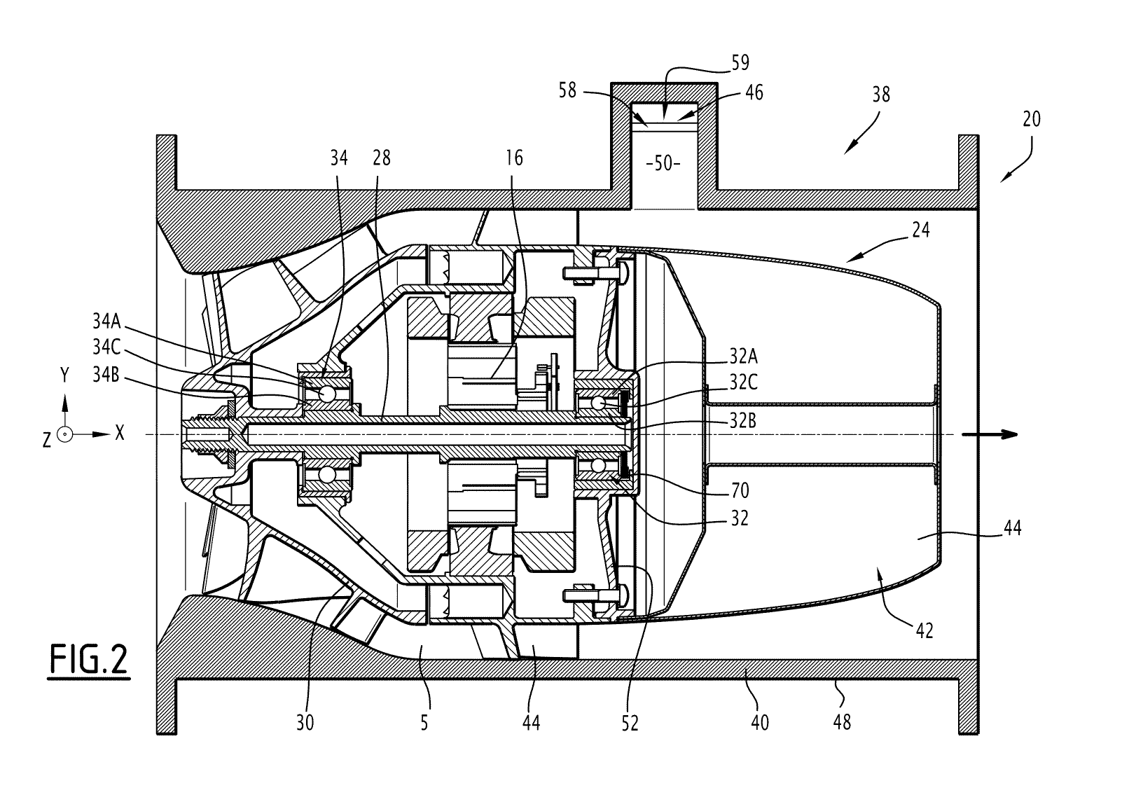

The fan 20 is shown in more detail in FIG. 2.

The fan 20 includes a support structure 24, a drive motor 26, a shaft 28, a wheel 30, two ball bearings 32, 34 and a failure detection system 58.

The support structure 24 includes an outer body 38, a duct 40, a bulb 42, arms 44 and a housing 46.

The duct 40 has a sidewall 48.

The duct 40 is a tubular duct extending along the longitudinal axis X.

The duct 40 defines, with the outer body 38, an inner space 50.

The bulb 42 has a chassis 52 bearing a fairing 54.

The duct 40 is rigidly connected to the chassis 52 to form the support structure 24.

The bulb 42 is connected to the duct 40 by the arms 44, such that an annular tunnel 56 is defined between the duct 40 and the bulb 42.

Each of the arms 44 is, according to the example of FIG. 2, a transverse arm extending in two transverse directions, a first transverse direction Y and a second transverse direction Z.

The housing 46 protrudes outward.

The housing 46 defines an inner space, which in the particular case of FIG. 2 corresponds exactly to the inner space 50.

The housing 46 includes the failure detection system 58.

The failure detection system 58 is an electronic board 59 supporting different components, which are shown in FIG. 3.

The electronic board 59 assumes the general form of a plate extending in a plane normal to the first transverse direction Y.

The electronic board 59 is in the inner space 50.

The electronic board 59 includes a sensor 36 and a processing chain 60.

The sensor 36 includes an outlet 36S.

The sensor 36 is a sensor for measuring a mechanical parameter representative of the dynamic behavior of the or each bearing 32, 34.

For example, the vibration emitted by the bearings 32, 34 and transmitted along the body of the fan 20 is a mechanical parameter representative of the dynamic behavior of the or each bearing 32, 34.

The sensor 36 is thus able to deliver a signal on the output 36S representative of the measured mechanical parameter.

According to the example of FIG. 2, the sensor 36 is a micro-electromechanical system.

A micro-electrochemical system is a microsystem comprising one or more mechanical elements, using electricity as a power source, in order to perform a sensor and/or actuator function, with at least one structure having micrometric dimensions. The function of the system is partially ensured by the shape of the structure. The term “micro-electromechanical system” is abbreviated using the acronym MEMS.

Alternatively, the sensor 36 is an accelerometer.

According to another embodiment, the sensor 36 is a piezoelectric sensor.

The processing chain 60 includes a sampler 62 and a computing module 64.

The sampler 62 includes an input 62E and an output 62S.

The input 62E of the sampler 62 is connected to the output 36S of the sensor 36, while the output 62S of the sampler 62 is connected to the computing module 64.

The sampler 62 is able to perform sampling of the signal coming from the sensor 36.

The sampling frequencies are comprised between 15 kHz (kilohertz) and 50 kHz, depending on the need and the application.

Typically, a ratio of 2.6 is applied between the sampling frequency and the maximum frequency of the frequency measurement band in which a Fourier transform is calculated. In particular, for a measuring frequency band comprised between 10 Hz and 6 kHz, the sampling frequency is chosen at 15 kHz, whereas for a measuring frequency band comprised between 10 Hz and 20 kHz, the sampling frequency is chosen at 50 kHz.

For example, the sampler 62 is able to perform sampling with a frequency of 20 kHz (kilohertz), such that 20,000 samples per second are collected at the output of the sampler 62.

The computing module 64 includes an input 64E and an output 64S. The input 64E of the computing module 64 is connected to the output 62S of the sampler 62.

The computing module 64 is able to implement a direct Fourier transform of the samples of the collected parameter.

In other words, the computing module 64 is able to perform a Fourier series decomposition of the samples provided by the sampler 62 in order to obtain the coefficients of the Fourier series for different frequency components.

For example, the frequency components for which a coefficient of the Fourier series is obtained by the computing module have a frequency comprised between 10 Hz and 6 kHz or between 10 Hz and 20 kHz, depending on the need and application.

Furthermore, the interval between the frequency components is chosen to obtain between 200 and 1600 different coefficients. To that end, the interval is comprised between 1 Hz and 5 Hz.

The computing module 64 is able to compute a plurality of criteria, each criterion being representative of a malfunction of the bearings 32, 34.

Each criterion consists of comparing the mechanical energy produced by the fan 20 on a frequency band to a reference level.

Depending on the case, the frequency band is specific or broad.

For the case of a specific frequency band, the mechanical energy is obtained by computing the quadratic sum of the coefficients of the Fourier series decomposition, the associated frequency of which is comprised in the specific frequency band.

As an example, the specific frequency band is the band grouping together the frequencies comprised between 180 Hz and 220 Hz. The mechanical energy is then calculated by adding the squares of each of the coefficients of the Fourier series decomposition whose frequency is comprised between 180 Hz and 220 Hz.

The mechanical energy on the frequency band is then compared to a reference level corresponding to a fan operating nominally. If the calculated mechanical energy is strictly above the reference level, this indicates wear of the bearings 32, 34.

The specific frequency bands are determined as a function of a specific failure, such that if a criterion associated with a specific frequency band is not verified, it is possible to determine the failure type.

Such a criterion is qualified hereinafter as “local criterion”.

When the frequency band is broad, generally all of the analyzed frequencies, i.e., between 10 Hz and 6 kHz or between 10 Hz and 20 kHz, the mechanical energy is also calculated. The mechanical energy is next compared to a reference level corresponding to a fan operating nominally. If the calculated mechanical energy is strictly higher, this indicates wear of the bearings 32, 34.

Such a criterion is qualified hereinafter as “global criterion”.

Preferably, the computing module 64 is able to implement a plurality of local criteria and the global criterion to detect any possible malfunction.

The motor 26 is supported by the chassis 52 and housed inside the fairing 54. Furthermore, the motor 26 is positioned along the axis of the fan 20.

The rotor of the motor 26 is secured to the shaft 28, while the stator of the motor 26 is secured to the chassis 52.

The shaft 28 is coupled to the drive motor 26.

The wheel 30 is supported by one end of the shaft 28.

In the illustrated embodiment, the wheel 30 hugs the shape of the bulb 42. The wheel 30 is positioned on the side of the bulb 42 by which the air is suctioned.

The two ball bearings 32 and 34 support the shaft 28.

The two bearings 32 and 34 are positioned on either side of the motor 26.

The first bearing 32, also called front bearing 32, is positioned between the motor 26 and the wheel 30.

The second bearing 34, also called rear bearing 34, is positioned opposite the wheel 30 relative to the motor 26.

Each bearing 32, 34 includes an outer ring 32A, 34B secured in rotation relative to the chassis 42 and an inner ring 32B, 34B secured in rotation with the shaft 28, as well as rolling elements, in particular balls 32C, 34C inserted between the two rings 32A, 34A, 32B, 34B.

A retaining cage of the balls, formed by a cylindrical shroud pierced with receiving housings for the balls 32C, 34C, ensures an equal distribution of the balls 32C, 34C and correct positioning of the balls 32C, 34C between the two rings 32A, 34A, 32B, 34B.

The rear bearing 34 is axially loaded by elastic washers 70 positioned around the shaft 28 and applied between the outer ring 34A of the second bearing 34 and the chassis 42. Such elastic washers 70 form a spring and push the outer ring 34A of the second bearing 34 back toward the wheel 30.

The operation of the fan 20 will now be described.

The sensor 36 continuously measures a parameter representative of the dynamic behavior of the bearings 32, 34.

The parameter measured by the sensor 36 is continuously processed by the processing chain 60, which monitors local criteria and the global criterion.

In other words, the fan 20 makes it possible to detect damage to the bearings 32 owing to the detection of the increased vibrational level on specific frequency bands.

More specifically, the fan 20 makes it possible to meet two different needs.

On the one hand, the fan 20 makes it possible to detect failure cases corresponding to a deterioration of a bearing 32 not challenging the operation of the equipment. In such a case, an alert is sent to the operator to schedule maintenance to replace the equipment before a consequence occurs for the operation of the aircraft 10.

On the other hand, the fan 20 makes it possible to detect failure cases corresponding to deterioration of the bearing 32 challenging the operation of the equipment. In such a case, the equipment is stopped to avoid consequences from occurring for the operation of the airplane 10. Redundant equipment is also used to replace the faulty equipment.

The fan 20 has the advantage of being easier to implement.

Indeed, the sensor 36 is integrated into the fan 30, which results in saving mass and volume.

Furthermore, the assembly of the acquisition chain 60 and the sensor 36 is integrated into the electronic board 58, which is easy to integrate.

Furthermore, the use of a wired connection between the sensor 36 and the electronic board is avoided, that wired connection often being relatively unreliable.

According to one particular environment, the sensor 36 is unique, which still further simplifies the implementation of the fan 20.

According to another particular embodiment, the failure detection system 58 further includes an anti-overlap filter positioned between the sensor 36 and the sampler 62. Depending on the case, the filter is an additional physical element or software implemented by the computing module 64.

1. A fan including:
a drive motor,
a shaft coupled to the drive motor,
a wheel supported by the shaft,
a support structure, the support structure including:
an outer body,
a duct comprising a sidewall, the duct defining, with the outer body, an inner space, and
a housing situated in the inner space and in contact with the sidewall, the housing defining an inner volume,
at least one ball bearing inserted between the shaft and the support structure, and
a sensor for measuring a mechanical parameter representative of the dynamic behavior of the or each bearing, said sensor being positioned in the inner volume defined by the housing.

2. The fan according to claim 1, wherein the housing includes an electronic board, the electronic board including the sensor.

3. The fan according to claim 1, wherein the housing includes a processing chain connected to the sensor and able to perform a Fourier series decomposition of the vibrational behavior of the bearing.

4. The fan according to claim 3, wherein the processing chain is able to perform a Fourier series decomposition of the vibrational behavior of the bearing for frequencies comprised between 10 Hz and 20 kHz, preferably between 10 Hz and 6 kHz.

5. The fan according to claim 3, wherein the processing chain is able to calculate at least one mechanical energy associated with the vibrational behavior of the bearing over a frequency band and to compare the calculated mechanical energy to a reference level.

6. The fan according to claim 5, wherein the reference level is the mechanical energy associated with the vibrational behavior of the bearing of a fan during normal operation on the considered frequency band.

7. The fan according to claim 1, wherein the housing includes an electronic board, the electronic board including the sensor and the processing chain.

8. The fan according to claim 1, wherein the sensor is a micro-electromechanical system.

9. The fan according to claim 1, wherein the fan includes a single sensor for measuring a mechanical parameter representative of the dynamic behavior of the or each bearing.

10. An aircraft including a fan according to claim 1.
